(19) United States
(12) Patent Application Publication
(10) Pub. No.: US 2015/0015510 A1
(43) Pub. Date: Jan. 15, 2015

(54) ELECTRONIC DEVICE AND METHOD FOR DRAWING PICTURES

(71) Applicant: FIH (HONG KONG) LIMITED, Kowloon (HK)

(72) Inventor: CHAO-SHUAN HUANG, New Taipei (TW)

(21) Appl. No.: 14/326,653

(22) Filed: Jul. 9, 2014

(30) Foreign Application Priority Data
Jul. 10, 2013 (TW) 102124731

(51) Int. Cl. G06F 3/041; G06T 11/20

(52) U.S. Cl. CPC G06F 3/0416; G06T 11/203
USPC 345/173

(57) ABSTRACT

In a drawing method executed in an electronic device, the electronic device includes a touch screen, a touch controller, a decoder, a main processor, a frame buffer, and a display controller. The main processor initializes a line width, a line color, and a drawing region of the touch screen. The touch controller senses touch points on the touch screen, and generates coordinates of the touch points. The decoder receives the coordinates of the touch points from the touch controller, and updates the frame buffer according to the line width, the line color, the drawing region, and the coordinates of the touch points. The display controller updates a display of the touch screen according to contents in the frame buffer to display a picture.

### CROSS-REFERENCE TO RELATED APPLICATIONS

This application claims priority to Taiwan Patent Application No. 102124731 filed on Jul. 10, 2013 in the Taiwan Intellectual Property Office, the contents of which are incorporated by reference herein.

### FIELD

The subject matter herein generally relates to computer interfaces.

### BACKGROUND

Touch screens are widely used in electronic devices such as mobile phones. Users may slide a finger or a stylus on the touch screens to draw pictures.

### BRIEF DESCRIPTION OF THE DRAWINGS

Implementations of the present technology will now be described, by way of example only, with reference to the attached figures.

FIG. 1 is a block diagram of an embodiment of an electronic device.

FIG. 2 is a flowchart of an embodiment of a drawing method using an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like. The term “coupled” is defined as connected, whether directly or indirectly through intervening components, and is not necessarily limited to physical connections. The connection can be such that the objects are permanently connected or releasably connected. The term “electronically coupled” can include any coupling that is via a wired or wireless connection. The electronic coupling can be through one or more components or it can include a direct connection between the described components.

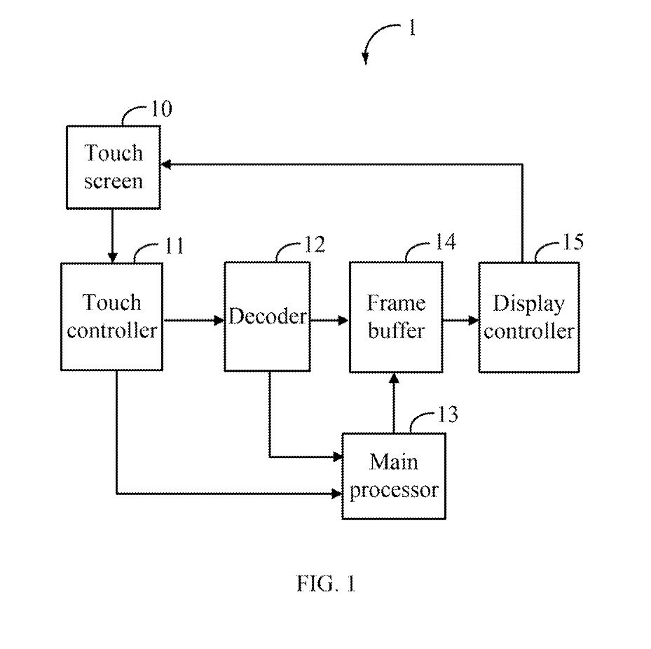

FIG. 1 is a block diagram of an embodiment of an electronic device. The electronic device 1 can include a touch screen 10, a touch controller 11, a decoder 12, a main processor 13, a frame buffer 14, and a display controller 15. The touch screen 10 can be electronically coupled to the touch controller 11 and the main processor 13. The main processor 13 can be further electronically coupled to the decoder 12 and the frame buffer 14. The frame buffer 14 can be further electronically coupled to the decoder 12 and the display controller 15. When a user slides his finger or a stylus on the touch screens 10 to draw pictures, the electronic device 1 can quickly display the pictures on the touch screen 10. The touch screen 10 can be a resistive touch screen, a capacitive touch screen, or any other type of touch screen.

The main processor 13 initializes a line width, a line color, and a drawing region of the touch screen 10, and writes the line width, the line color, and the drawing region to the decoder 12.

When the user slides an object on the touch screen 10 to draw a picture, the touch controller 11 senses touch points on the touch screen 10, and generates coordinates of the touch points.

The decoder 12 receives the coordinates of the touch points from the touch controller 11, and updates a frame buffer 14 according to the line width, the line color, the drawing region, and the coordinates of the touch points.

The display controller 15 updates a display of the touch screen 10 according to contents in the frame buffer 14.

After generating the coordinates of the touch points on the touch screen 10, the touch controller 11 triggers an interrupt to the main processor 13.

In response to the interrupt, the main processor 13 reads the coordinates of the touch points from the touch controller 11, and determines whether the user has finished drawing the picture. In the embodiment, the main processor 13 can determine that the user has finished drawing the picture if no new coordinates of touch points are read from the touch controller 11 after a predetermined interval (for example, 2 seconds).

When the picture has been drawn, the main processor 13 turns off the decoder 12 so that the decoder 12 stops updating the frame buffer 14 according to the line width, the line color, the drawing region, and the coordinates of the touch points received from the touch controller 11. The main processor 13 generates the picture according to the coordinates of the touch points, and executes a special effect process on the picture to obtain a special picture. For example, the main processor 13 can execute an embossing of lines of the picture to obtain a relief picture. The main processor 13 updates the frame buffer 14 with the special picture.

The display controller 15 updates the display of the touch screen 10 according to the frame buffer 14 so the special picture is displayed on the touch screen 10.

After the special picture is displayed on the touch screen 10, the main processor 13 turns on the decoder 12, so that the decoder 12 continues to update the frame buffer 14 according to the line width, the line color, the drawing region, and the coordinates of the touch points received from the touch controller 11.

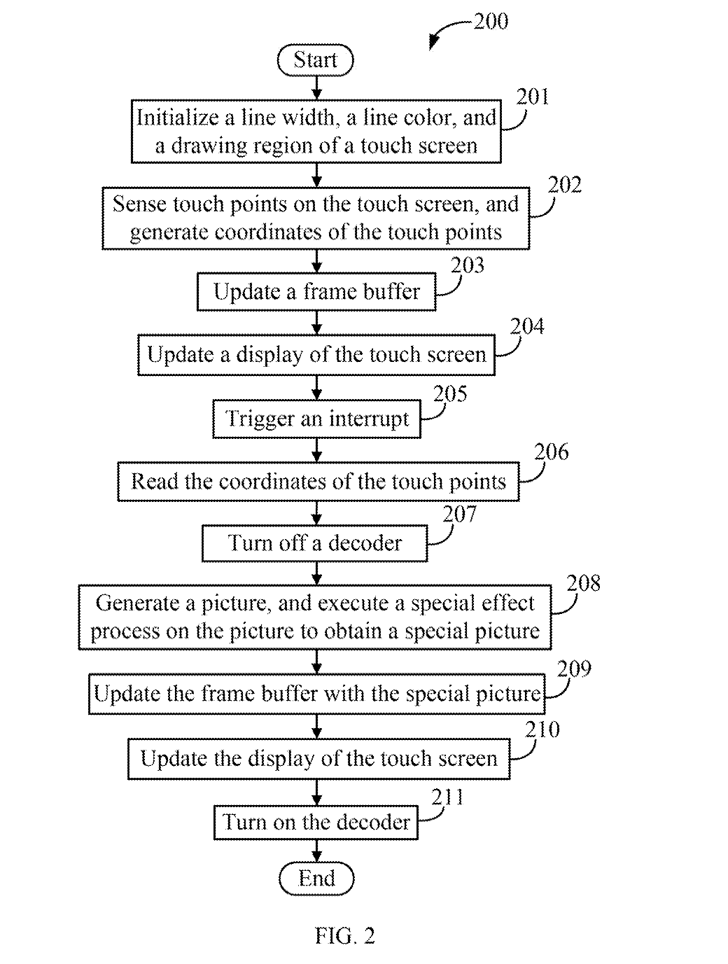

FIG. 2 is a flowchart of one embodiment of a drawing method using an electronic device which includes a touch screen, a touch controller, a decoder, a main processor, a frame buffer, and a display controller.

Referring to FIG. 2, a flowchart is presented in accordance with an embodiment. The method 200 is provided by way of example, as there are a variety of ways to carry out the method. The method 200 described below can be carried out using the configurations illustrated in FIG. 1, for example, and various elements of these figures are referenced in explaining method 200. Each block shown in FIG. 2 represents one or more processes, methods, or subroutines, carried out in the method 200. Furthermore, the illustrated order of blocks is illustrative only and the order of the blocks can be changed. Additional blocks can be added or fewer blocks may be utilized without departing from this disclosure. The method 200 can begin at block 201.

At block 201, the main processor initializes a line width, a line color, and a drawing region of the touch screen. The main processor further writes the line width, the line color, and the drawing region to the decoder. For example, the line width is initialized as 1.2 pt. The line color is initialized as blue. The drawing region can be initialized as a whole display region of the touch screen or a part of the whole display region of the touch screen. In at least one embodiment, the decoder includes several registers. The main processor writes the line width, the line color and the drawing region to the registers.

When a user slides an object on the touch screen to draw a picture, at block 202, the touch controller senses touch points on the touch screen, and generates coordinates of the touch points. In at least one embodiment, the touch controller can include a plurality of touch sensors. When the user touches the touch screen using the object, each touch point is detected by the touch sensors.

At block 203, the decoder receives the coordinates of the touch points from the touch controller, and updates a frame buffer according to the line width, the line color, the drawing region, and the coordinates of the touch points. The frame buffer can store pixel information of each pixel in the drawing region. The decoder determines which pixels are to be activated in the in the drawing region according to the coordinates of the touch points, and updates the pixel information of the determined pixels according to the line width and the line color. The pixel information can include a color value and transparency of each pixel. The color value can be an RGB value.

At block 204, the display controller updates a display of the touch screen according to the frame buffer. The display controller can update the display of the touch screen at a predetermined frequency, such as 240 Hz, for example. The picture drawn by the user is thus displayed on the touch screen.

After generating the coordinates of the touch points on the touch screen, at block 205, the touch controller triggers an interrupt to the main processor.

In response to the interrupt, at block 206, the main processor reads the coordinates of the touch points from the touch controller, and determines whether the user has finished drawing the picture. The main processor can determine that the user has finished drawing the picture if no new coordinates of touch points are read from the touch controller.

When the use has finished drawing the picture, at block 207, the main processor turns off the decoder, so that the decoder stops updating the frame buffer according to the line width, the line color, the drawing region, and the coordinates of the touch points received from the touch controller.

At block 208, the main processor generates the picture according to the coordinates of the touch points, and executes a special effect process on the picture to obtain a special picture. For example, the main processor can execute an embossing of lines of the picture to obtain a relief picture.

At block 209, the main processor updates the frame buffer with the special picture.

At block 210, the display controller updates the display of the touch screen according to the frame buffer. Therefore, the special picture is displayed on the touch screen.

At block 211, the main processor turns on the decoder, so that the decoder continues to update the frame buffer according to the line width, the line color, the drawing region, and the coordinates of the touch points received from the touch controller.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size, and arrangement of parts within the principles of the present disclosure, up to and including the full extent established by the broad general meaning of the terms used in the claims.

What is claimed is:

1. A drawing method being executed by an electronic device comprising a touch screen, a touch controller, a decoder, a main processor, a frame buffer, and a display controller, the method comprising:
initializing, by the main processor, a line width, a line color, and a drawing region of the touch screen;
sensing, by the touch controller, touch points on the touch screen, and generating, by the touch controller, coordinates of the touch points;
receiving, by the decoder, the coordinates of the touch points from the touch controller, and updating, by the decoder, the frame buffer according to the line width, the line color, the drawing region, and the coordinates of the touch points; and
updating, by the display controller, a display of the touch screen according to the frame buffer to display a picture.

2. The method according to claim 1, further comprising:
triggering an interrupt to the main processor by the touch controller after the coordinates of the touch points are generated;
in response to the interrupt, reading the coordinates of the touch points from the touch controller by the main processor, and determining whether a picture drawing is finished;
causing the decoder to stop updating the frame buffer by the main processor according to the line width, the line color, the drawing region, and the coordinates of the touch points received from the touch controller, when the picture drawing is finished;
generating the picture by the main processor according to the coordinates of the touch points, and executing a special effect process on the picture by the main processor to obtain a special picture;
updating the frame buffer with the special picture by the main processor;
updating the display of the touch screen by the display controller according to the frame buffer; and
controlling the decoder to continue to update the frame buffer by the main processor according to the line width, the line color, the drawing region, and the coordinates of the touch points received from the touch controller.

3. The method according to claim 1, wherein the frame buffer stores pixel information of each pixel in the drawing region.

4. The method according to claim 3, wherein the decoder updates the frame buffer by determining which pixels are to be activated in the drawing region according to the coordinates of the touch points, and updating the pixel information of the determined pixels according to the line width and the line color.

5. The method according to claim 3, wherein the pixel information comprises a color value and transparency of each pixel.

6. An electronic device comprising a touch screen, a touch controller, a decoder, a main processor, a frame buffer, and a display controller, wherein:
the main processor initializes a line width, a line color, and a drawing region of the touch screen;
the touch controller senses touch points on the touch screen, and generates coordinates of the touch points;
the decoder receives the coordinates of the touch points from the touch controller, and updates the frame buffer according to the line width, the line color, the drawing region, and the coordinates of the touch points; and
the display controller updates a display of the touch screen according to the frame buffer to display a picture.

7. The electronic device according to claim 6, wherein:
the touch controller further triggers an interrupt to the main processor after the coordinates of the touch points are generated;
in response to the interrupt, the main processor reads the coordinates of the touch points from the touch controller, and determines whether a picture drawing is finished;
the main processor controls the decoder to stop updating the frame buffer according to the line width, the line color, the drawing region, and the coordinates of the touch points received from the touch controller, when the picture drawing is finished;
the main processor generates the picture according to the coordinates of the touch points by the main processor, and executes a special effect process on the picture to obtain a special picture;
the main processor updates the frame buffer with the special picture;
the display controller updates the display of the touch screen according to the frame buffer; and
the main processor causes the decoder to continue to update the frame buffer according to the line width, the line color, the drawing region, and the coordinates of the touch points received from the touch controller.

8. The electronic device according to claim 6, wherein the frame buffer stores pixel information of each pixel in the drawing region.

9. The electronic device according to claim 8, wherein the decoder updates the frame buffer by determining which pixels are to be activated in the drawing region according to the coordinates of the touch points, and updating the pixel information of the determined pixels according to the line width and the line color.

10. The electronic device according to claim 8, wherein the pixel information comprises a color value and transparency of each pixel.
